(19) United States
(12) Patent Application Publication
(10) Pub. No.: US 2007/0096365 A1
(43) Pub. Date: May 3, 2007

(54) Lollipop Mold

(76) Inventors: Michael James Jones, Apple Valley, MN (US); Thomas John Babineau, St. Paul, MN (US); Martin Anton Erickson III, Apple Valley, MN (US)

Correspondence Address: MARTIN A. ERICKSON, III;GALLIPOT, INC., 2400 PILOT KNOB ROAD, ST. PAUL, MN, 55120, US

(21) Appl. No.: 11/163,739

(22) Filed: Oct. 28, 2005

(51) Int. Cl. B29C 43/02; B29C 39/26

(52) U.S. Cl. 264/259; 264/319; 249/119; 249/120; 249/117

(57) ABSTRACT

A single or multiple cavity mold is described. This mold may be used by Pharmacists to compound lollipops or troches with handles for administration orally. Various vehicles for this purpose currently are in use by Pharmacists: these may be but are not limited to: hard candy based, polyethylene glycol based, or glycerin (“chewy”) based. The vehicle may be molten with or without active ingredients or it may be solid and contain active and ingredients. The vehicle may be poured or compressed into the mold to form molded lollipops.

An apparatus for pharmacists' compounding of lollipop type preparations containing active and/or inactive ingredients for oral administration is described. The apparatus consists of multiple parallel parts of the same dimensions vertically and laterally, each part having a series of one-half cavities such that when the main parts are articulated, closed cavities with fill and handle holes result. Each cavity will yield a smooth-edged rectangular solid of predictable volume of the material with which it is filled. A hole for insertion of a handle by which the lollipop can be held while administering the material is formed when the mold parts are articulated and fastened together. The long axis of the cavity is parallel to the direction of insertion of the handle material. The handles are inserted through holes in the mold and held by friction when the mold parts are fastened together. The handles may be inserted from the tops of the mold cavities after filling with the vehicle to ensure placement when the material solidifies and is removed from the mold or they may be inserted prior to filling the mold cavities. The handles extend from well into the interior of the cavities to the surface on which the mold is placed. The mold is supported above the surface on which it rests by means of legs, dowels or other suitable device or mechanism comprised of, but not limited to, metal, plastic or other suitable material. The distance between the bottom of the mold and the surface is determined by the length of the handles to be used in the lollipops. The present embodiment is made of aluminum supported on aluminum rods which are adjustable to provide for differing handle lengths.

The cavities are arranged laterally in the mold, which is divided to allow disassembly for cleaning. The parts are held together by means of fasteners which can be but are not limited to, locks, bolts and nuts, or other suitable means. The present embodiment consists of 3 parts, one of which has ½ cavities on each side, the other two having half-cavities on only one side, such that when the three parts are bolted together 36 complete cavities are formed. The present embodiment is held together by means of stainless steel bolts inserted into holes drilled completely through the mold parts such that when bolts are inserted through them, the parts will be articulated to form said cavities. In the present embodiment, the bolts are secured by means of wing nuts on the side of the mold from which the bolts exit these holes.

What is claimed is:

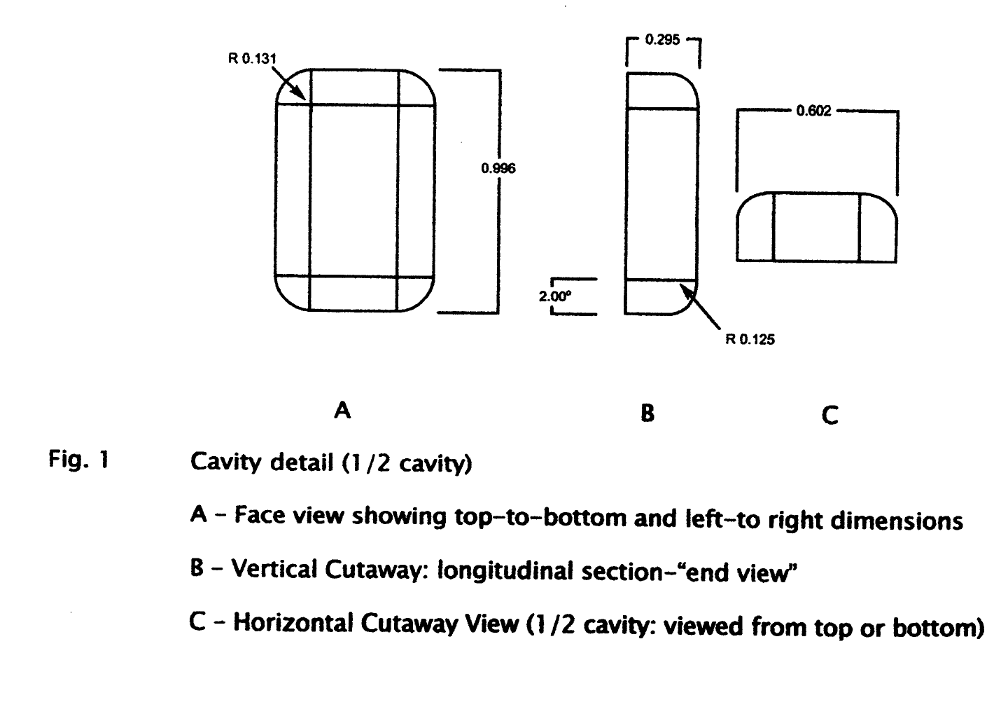

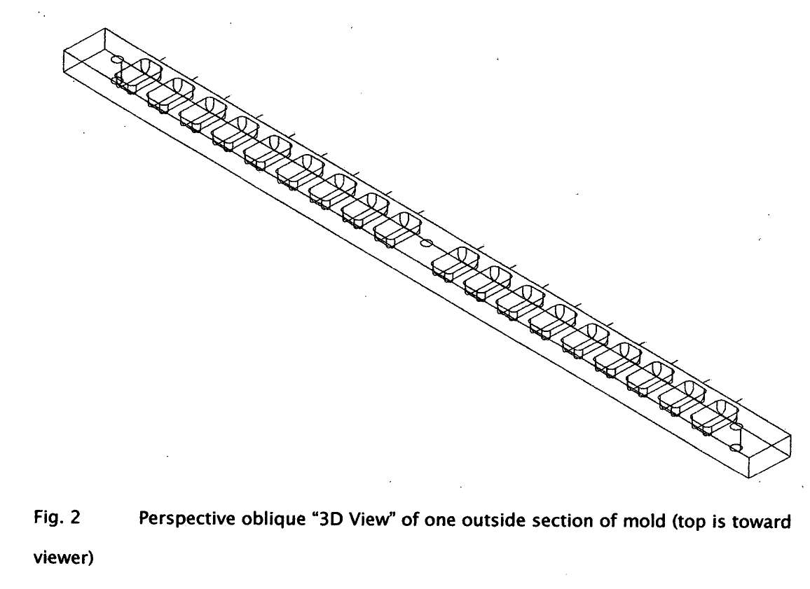

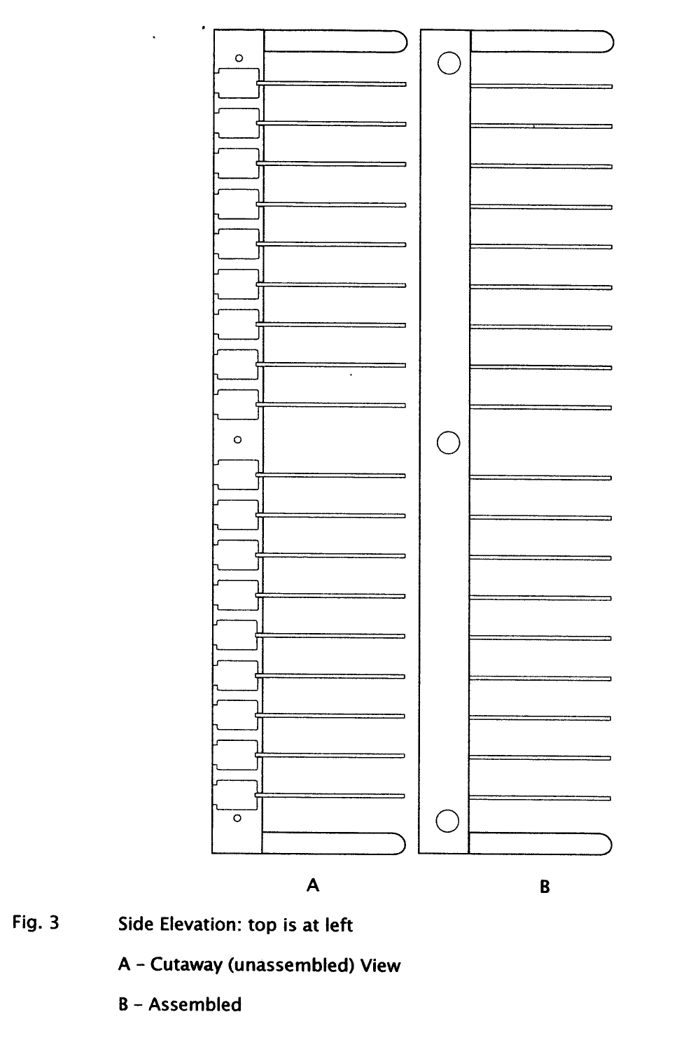

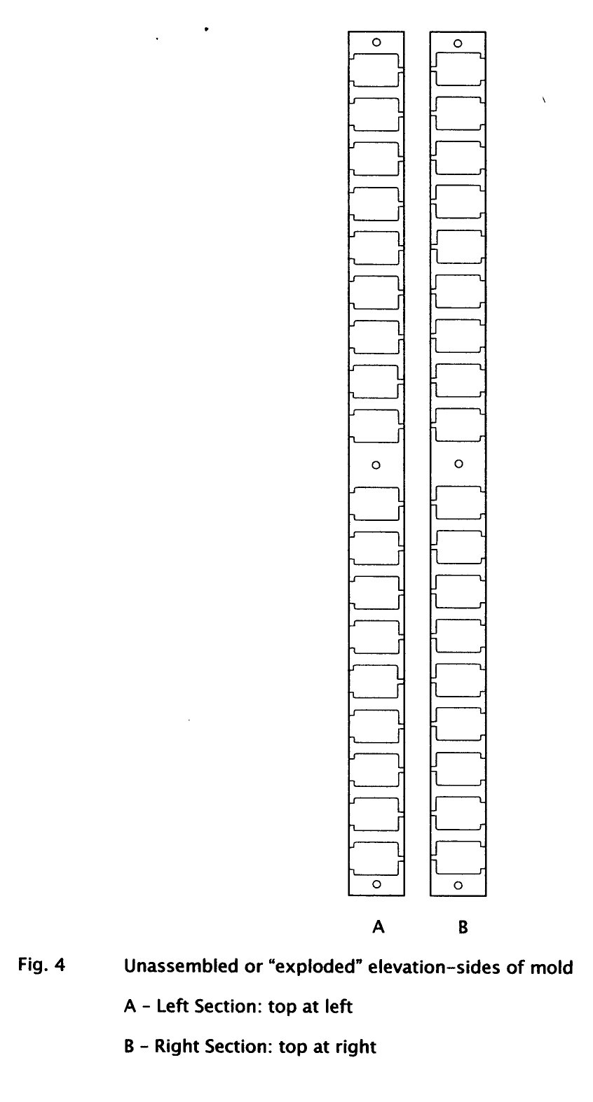

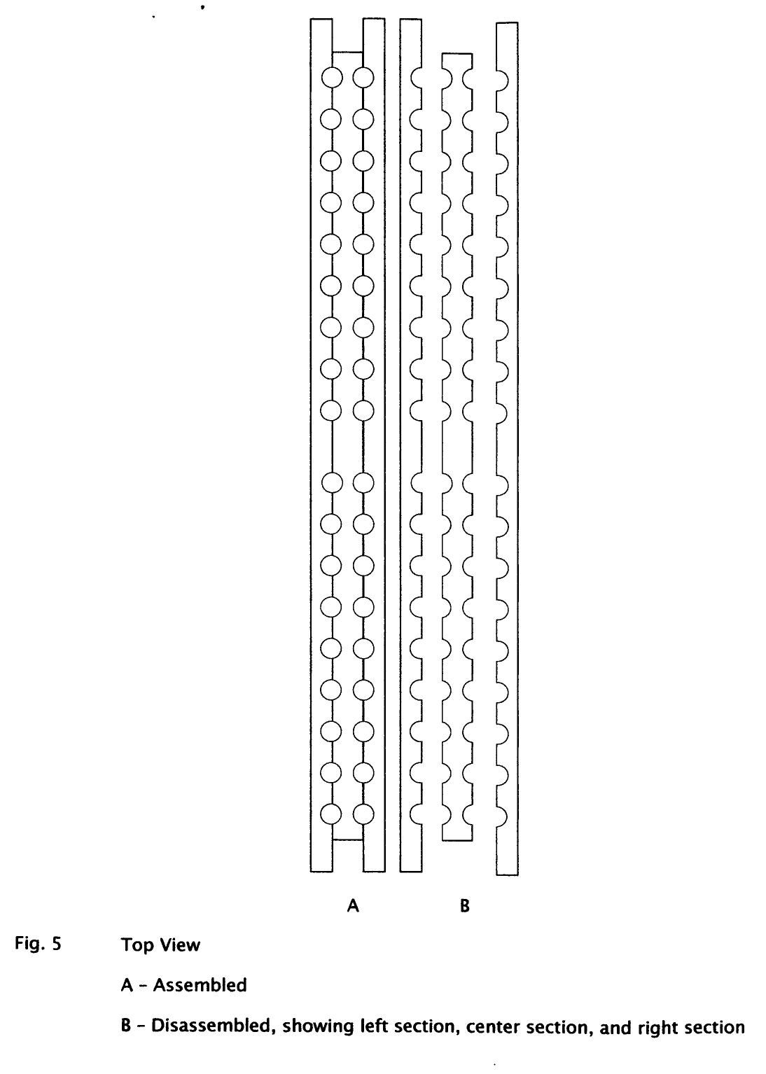

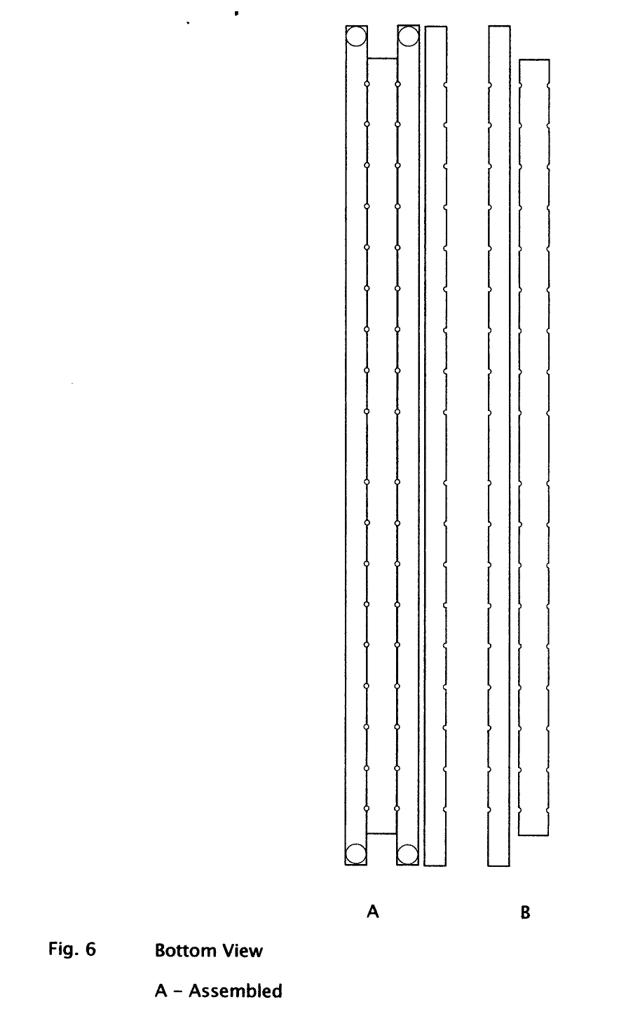

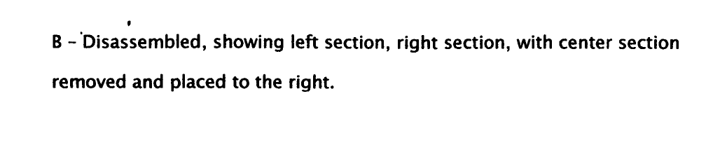

1. A mold for making molded dose forms comprising
a. Material having at least one-half cavity mating with material having one-half cavity. (See FIGS. 4, 5, and 6)
b. Each cavity having at least one hole therein when the parts are fastened together;
c. Legs supporting the material above a surface after mating the material. (See FIGS. 3A & B)

2. A method of making molded dose forms comprising the steps of
i. Melting a vehicle
ii. Combining active and/or inactive ingredients with the vehicle
iii. Connecting the material parts in 1a together to form a mold; (See FIGS. 3, 5 and 6)
iv. Adding a stick or handle to the empty mold;
v. Pouring the vehicle and ingredients, if any, in 2b into the mold cavities in 1b;
vi. Resting the material on the supporting legs;
vii. Allowing the vehicle to solidify
